(19) United States
(12) Patent Application Publication
(10) Pub. No.: US 2017/0278156 A1
(43) Pub. Date: Sep. 28, 2017

(54) METHODS AND APPARATUS FOR DETERMINING WHETHER A PRODUCT OR SELECTION OF PRODUCTS IS WITHIN A DUTY FREE ALLOWANCE

(71) Applicant: MasterCard International Incorporated, Purchase, NY (US)

(72) Inventor: Pravin Parekh, Pune (IN)

(21) Appl. No.: 15/466,198

(22) Filed: Mar. 22, 2017

(30) Foreign Application Priority Data
Mar. 23, 2016 (SG) 10201602300Q

(51) Int. Cl. G06Q 30/06

(52) U.S. Cl. CPC G06Q 30/0607; G06Q 30/0637

(57) ABSTRACT

A computer implemented method of providing an indication whether a basket content is within a duty free allowance is disclosed. The method comprises receiving, in a duty free allowance analysis server, destination indication information for a passenger; determining, in a destination look up component of the duty free allowance analysis server, a destination of the passenger from the destination indication information; looking up a duty free allowance for the destination in a duty free allowance database; receiving, in the duty free allowance analysis server, an indication of a basket content, the basket content comprising at least one product selected by the passenger; looking up product information for the basket content in a product database; comparing, in a duty free allowance analysis component of the duty free allowance analysis server, product content information determined from the product information with the duty free allowance for the destination; and outputting an indication of whether the basket content is within the duty free allowance.

### CROSS-REFERENCE TO RELATED APPLICATION

This application is a U.S. National Stage filing under 35 U.S.C. §119, based on and claiming benefit of and priority to SG Patent Application No. 10201602300Q filed Mar. 23, 2016.

### TECHNICAL FIELD AND BACKGROUND

The present disclosure relates to the analysis of the content of shopping basket or shopping trolley. In particular, it relates to the determination of whether the content of the shopping basket or shopping trolley is within a duty free allowance.

Duty free shops are often found at airports. In a duty free shop, a consumer can purchase products such as alcohol, tobacco and other goods without paying local duty or taxes. Many countries impose an import duty on products into the country. However there is often a duty free allowance that a traveler may bring into a country without paying such an import duty. This duty free allowance and the way in which it is calculated varies between countries.

It is therefore desirable to provide customers of duty free shops with an indication of whether their purchases are within the duty free allowance for their destination country.

### SUMMARY

In general terms, the present disclosure proposes methods and systems in which in a duty free allowance for a destination country of a traveler shopping at a duty free shop is determined and this duty free allowance is compared with a product or a number of products selected by the traveler.

According to a first aspect of the present invention, there is provided a computer implemented method of providing an indication whether a basket content is within a duty free allowance. The method comprises receiving, in a duty free allowance analysis server, destination indication information for a passenger; determining, in a destination look up component of the duty free allowance analysis server, a destination of the passenger from the destination indication information; looking up a duty free allowance for the destination in a duty free allowance database; receiving, in the duty free allowance analysis server, an indication of a basket content, the basket content comprising at least one product selected by the passenger; looking up product information for the basket content in a product database; comparing, in a duty free allowance analysis component of the duty free allowance analysis server, product content information determined from the product information with the duty free allowance for the destination; and outputting an indication of whether the basket content is within the duty free allowance.

In an embodiment the destination indication information for the passenger is an indication of a travel document for the passenger and wherein determining a destination of the passenger from the destination indication information comprises looking up the destination of the passenger in an airline passenger database.

The travel document may be for example a boarding pass for the passenger.

In an embodiment the method further comprises looking up an indication of an age of the passenger in the airline passenger database, and wherein looking up a duty free allowance for the destination further comprises looking up a minimum age associated with a duty free allowance for the destination, the method further comprising comparing the age of the passenger with the minimum age associated with a duty free allowance for the destination.

In an embodiment the method further comprises outputting an indication of a remaining duty free allowance for the passenger.

In an embodiment the duty free allowance for the destination specifies the duty free allowance as an indication of at least one product type and a duty free amount of that product type, and wherein the method further comprises determining product content information from the product information, the product content information indicating content amount of the product type contained within the product.

In an embodiment the method comprises looking up a price for each product in the basket and calculating a total price for the basket.

In an embodiment the method further comprises processing a payment for the products in the basket over a payment network.

The method may be implemented by, for example, a server having a computer processor and data storage device storing software components or instructions to carry out the operations disclosed above.

According to a second aspect of the present invention, there is provided a non-transitory computer-readable medium. The computer-readable medium has stored thereon program instructions for causing at least one processor to perform operations of a method disclosed above.

According to a further aspect of the present invention, there is provided an apparatus for providing an indication whether a basket content is within a duty free allowance. The apparatus comprises a computer processor and a data storage device, the data storage device having a destination look up component, a duty free allowance look up component, a product look up component and a duty free allowance analysis component comprising non-transitory instructions operative by the processor to: receive destination indication information for a passenger; determine a destination of the passenger from the destination indication information; looking up a duty free allowance for the destination in a duty free allowance database; receive an indication of a basket content, the basket content comprising at least one product selected by the passenger; look up product information for the basket content in a product database; compare product content information determined from the product information with the duty free allowance for the destination; and output an indication of whether the basket content is within the duty free allowance.

### BRIEF DESCRIPTION OF THE DRAWINGS

Embodiments of the invention will now be described for the sake of non-limiting example only, with reference to the following drawings in which:

FIG. 1 illustrates an apparatus for determining whether a product or selection of products is within a duty free allowance according to an embodiment of the present invention;

FIG. 2 is a block diagram showing a technical architecture of the duty free allowance analysis server;

FIG. 3 is a block diagram of a user device according to an embodiment of the present invention;

FIG. 4 illustrates an example of the duty free allowance data stored by a duty free allowance database used in embodiment of the present invention;

FIG. 5 shows a method carried out by the duty free allowance analysis server of determining whether a basket content is within a duty free allowance according to an embodiment of the present invention; and

FIG. 6 shows a method according to an embodiment of the present invention which may be carried out by a duty free allowance analysis server and a user device to determine whether a basket content is within a duty free allowance.

### DETAILED DESCRIPTION

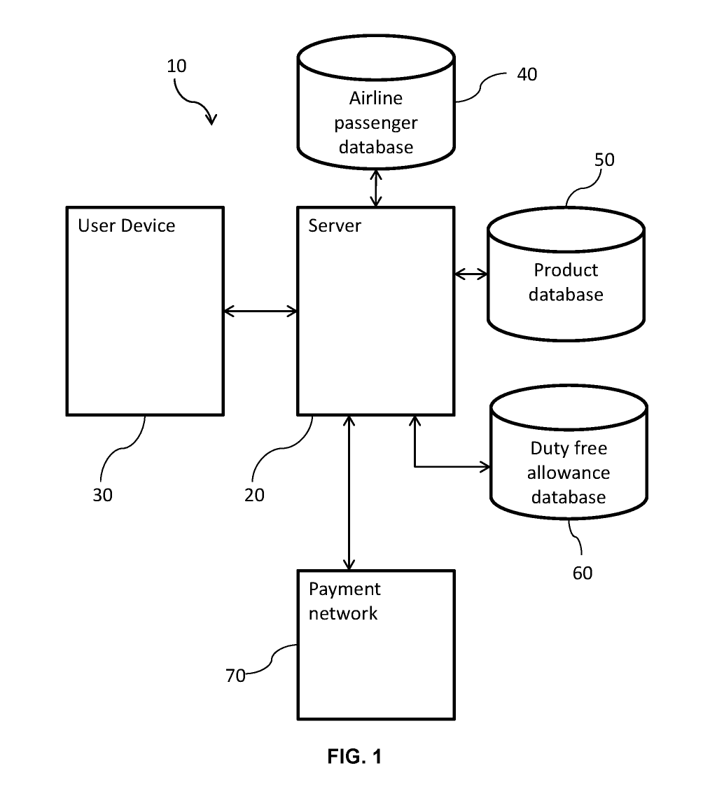

FIG. 1 illustrates an apparatus for determining whether a product or selection of products is within a duty free allowance according to an embodiment of the present invention. The apparatus 10 comprises a duty free allowance analysis server 20 and a user device 30. The user device 30 may be for example a mobile telephone or tablet device, or electronic device coupled to a shopping basket or shopping trolley. The duty free allowance analysis server is coupled to an airline passenger database 40, a product database 50, a duty free allowance database 60 and a payment network 70.

During methods according to embodiments of the present invention, the user device 30 is operated by a passenger traveling to a destination country. The passenger uses the user device 30 to scan products in a duty free shop. The user device 30 and the duty free allowance analysis server 20 communicate over a network. The duty free allowance analysis server 20 looks up details of the products scanned by the passenger in the product database 50. The duty free allowance analysis server looks up a duty free allowance for the destination country in the duty free allowance database 60 and determines whether the product or products scanned by the passenger are within the duty free allowance for the destination country. The various communications may take place via any types of network, for example, virtual private network (VPN), the Internet, a local area and/or wide area network (LAN and/or WAN), and so on.

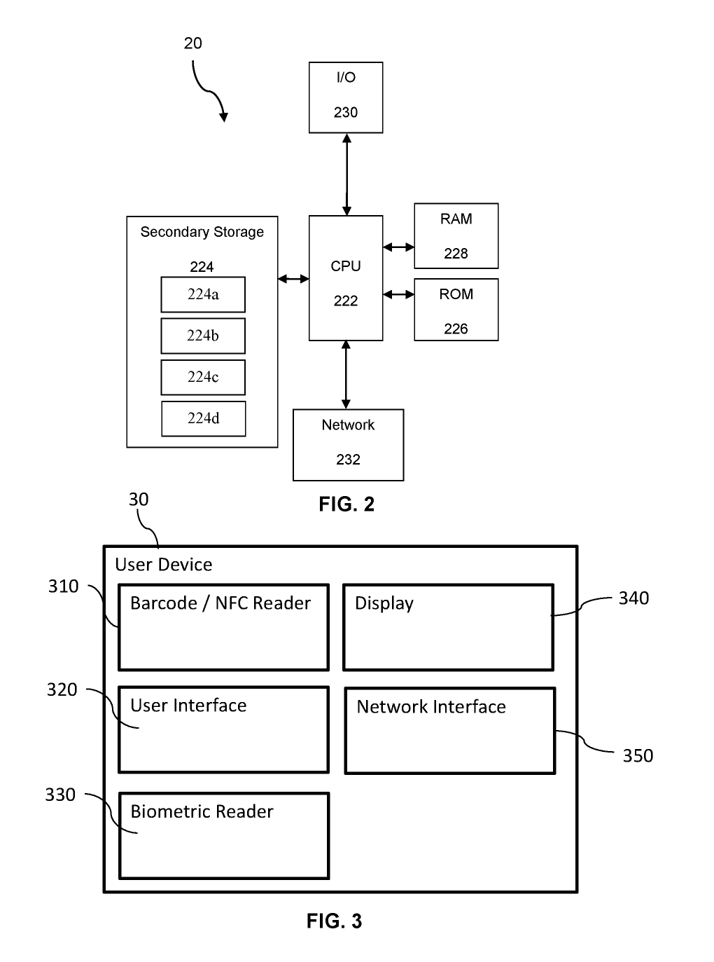

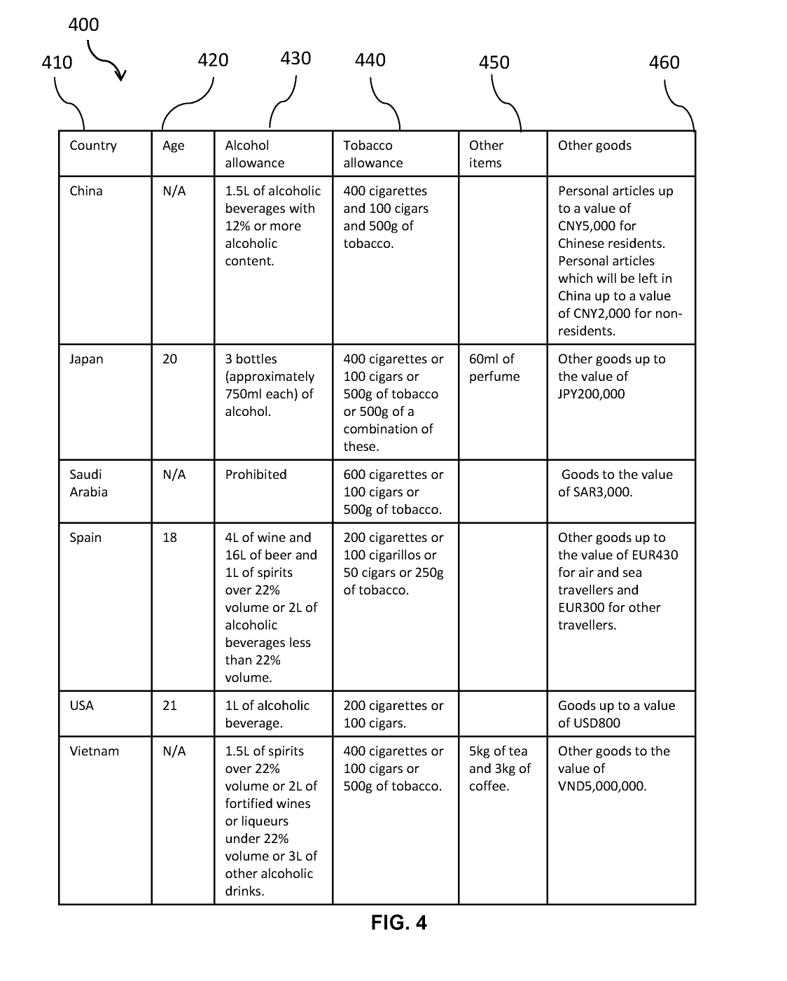

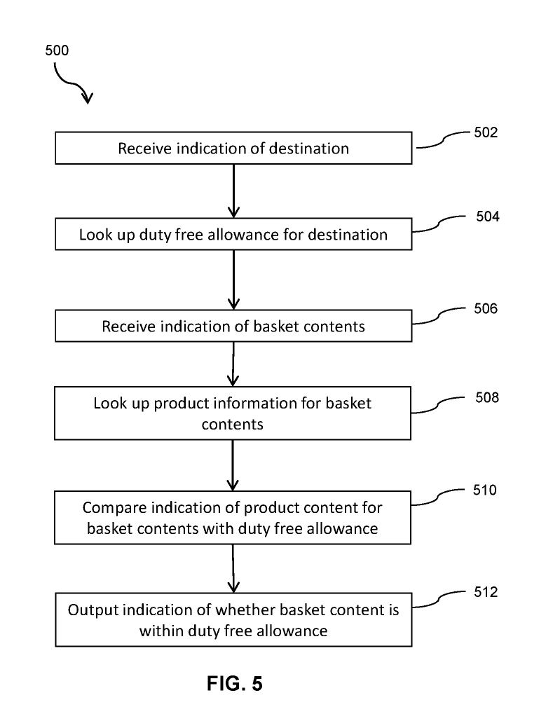

FIG. 2 is a block diagram showing a technical architecture of the duty free allowance analysis server 20 for performing exemplary methods which are described below with reference to FIGS. 4 and 5. Typically, the methods are implemented by a computer having a data-processing unit. The block diagram as shown FIG. 2 illustrates a technical architecture 20 of a computer which is suitable for implementing one or more embodiments herein.

The technical architecture 20 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a destination look-up component 224a, a duty free allowance look-up component 224b, a product look-up component 224c, and a duty free allowance analysis component 224d comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 20 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 20. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 20, at least one of the CPU 222, the RAM 228, and the ROM 226 are changed, transforming the technical architecture 20 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 3 is a block diagram of a user device according to an embodiment of the present invention. The user device 30 may be a mobile phone or tablet device. Alternatively, the user device 30 may be attached to or mountable on a shopping trolley. The user device 30 comprises a barcode, radiofrequency identification (RFID), or near field communications (NFC) reader 310. In embodiments, for example, where the user device 30 is a mobile phone, or tablet device, the barcode reader may be implemented using a camera. The NFC reader 310 may be operable to read NFC tags attached to products in a duty free shop.

The user device 30 further comprises a user interface 320 which may be, for example, a touch screen, keyboard, or track pad. The user device 30 further comprises a biometric reader 330, a display 340 and a network interface 350. The biometric reader may be for example a fingerprint reader. The network interface 350 may be a wireless network interface and allows the user device 30 to communicate with the duty free allowance analysis server 20.

FIG. 4 illustrates an example of the duty free allowance data stored by the duty free allowance database 60. FIG. 4 shows duty free allowance data for 6 countries, however, it will be appreciated that data for other countries may be included in the duty free allowance database 60. The duty free allowance data 400 comprises an indication of the following information for each country 410: the minimum age 420 for a passenger to have a duty free allowance when travelling to that country 430; the duty free alcohol allowance for that country; the duty free tobacco allowance for that country 440; the duty free allowance for other items 450; and the duty free allowance for other goods 460. As shown in FIG. 4, the minimum age 420 for a passenger to have duty free allowance varies for different countries. In some countries such as China and Saudi Arabia there is no minimum age. The manner in which the alcohol allowance 430 is specified varies between different countries. In Japan and the USA, the alcohol allowance 430 is specified in terms of the volume alone. In Spain, there is an allowance for each of a number of different types of alcohol. The tobacco allowance 440 is specified in terms of a number of cigarettes and/or cigars and a weight of tobacco. The other items 450 which have a specific duty allowance are perfume for which there is an allowance of 60 ml in Japan and tea and coffee for which there is an allowance of 5 kg and 3 kg respectively in Vietnam. The other goods allowance 460 specifies a value in the local currency of the country of other goods which may be brought into the country without paying duty. It is noted that in China the amount of this duty free allowance depends on whether the traveler is a Chinese resident. Further, alcohol is prohibited in some countries such as Saudi Arabia so there is no duty free allowance.

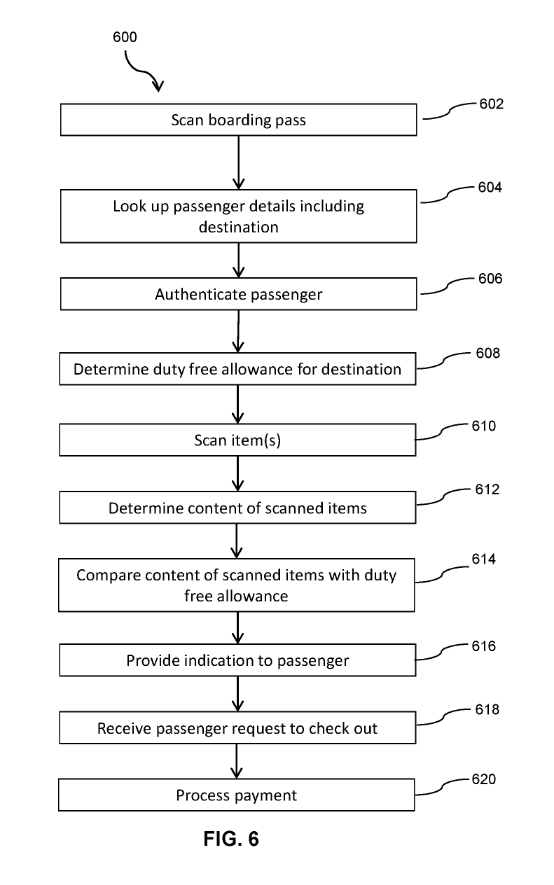

Various operations of the methods carried out by the duty free allowance analysis server 20 and the user device 30 will now be described with reference to FIGS. 5 and 6. FIGS. 5 and 6 illustrate methods of determining whether a product or a selection of products is within a duty free allowance. The method shown in FIG. 6 also incorporates a check out process for payment for the product or selection of products. It should be noted that enumeration of operations is for purposes of clarity and that the operations need not be performed in the order implied by the enumeration.

FIG. 5 shows a method 500, carried out by the duty free allowance analysis server 20, of determining whether a basket content is within a duty free allowance. At step 502, the duty free allowance analysis server 20 receives an indication of a destination for a passenger. The destination may be determined by the passenger scanning a boarding pass with user device 30 and the destination look up component 224a of the duty free allowance analysis server 20 using information received from the user device 30 to look up the passenger's destination using the airline passenger database 40. In addition, the duty free allowance analysis server 20 may also look up the passenger's age.

At step 504, the duty free allowance look up component 224b of the duty free allowance analysis server 20 looks up the duty free allowance for the destination country. As described above with reference to FIG. 4, the duty free allowance specifies an amount of various types of product that make up the duty free allowance for each country.

At step 506, the duty free allowance analysis server 20 receives an indication of a basket content from the user device 30. The passenger may use the user device 30 to scan the products in the basket in order to generate the indication of the basket contents. The indication of the basket contents may comprise for example bar codes or other product identifiers of the products in the passenger's shopping basket.

At step 508, product look up component 224c of the duty free allowance analysis server 20 uses the received indication of the basket contents to look up product details of the basket contents. The product details of the basket contents may specify the product type, and product content details. The product type may specify a product type such as alcohol and a product subtype such as beer, wine or spirits. Other possible product types may include tobacco, perfume, tea and coffee. The product content details may specify the amount of the product such as the volume or weight of the product and content information such as the alcohol content percentage or the number of cigarettes or cigars contained in the product.

At step 510, the duty free allowance analysis component 224d of the duty free allowance analysis server 20 compares an indication of the product content for the basket content with the duty free allowance. Step 510 may comprise the duty free allowance analysis component 224d determining an amount of each product or product sub-type is included in the basket and comparing that with the duty free allowance for the destination country. For example, if the destination country is Spain, the duty free allowance analysis component 224d will determine the amount of beer, wine and spirits contained in the basket and compare the amount of each with the duty free allowance specified in the duty free allowance for Spain.

At step 512, the duty free allowance analysis server 20 outputs an indication of whether the basket content is within the duty free allowance. Step 512 may comprise the duty free allowance analysis server 20 sending an indication to the user device 30 which is displayed on the display 340 of the user device.

In one embodiment, step 510 further comprises determining a remaining duty free allowance for the destination country and the indication output in step 512 further comprises an indication of the remaining duty free allowance. In such an embodiment, the display 340 of the user device 30 may also display the remaining duty allowance. This remaining duty free allowance may be displayed as the remaining amount of each product type and sub type, or as the amount of a specific product. For example, the remaining amount of each of beer, wine and spirit, or the number of bottles of a specific alcoholic beverage, may be displayed.

If, in step 510, it is determined that the amount of a product exceeds the duty free allowance for the destination country, then the indication sent in step 512 indicates that the duty free allowance has been exceeded. The products that exceed the duty free allowance may also be indicated so that the passenger may remove these items from the basket. If any of the items in the basket are prohibited in the destination country such as alcohol in Saudi Arabia, then this may also be indicated to the passenger.

FIG. 6 shows a method 600, carried out by the duty free allowance analysis server 20 and the user device 30, of determining whether a basket content is within a duty free allowance which comprises a check out process.

At step 602, the passenger scans their boarding pass using the user device 30. Step 602 may comprise the passenger using a camera of the user device 30 to read a QR code or bar code on the boarding pass. The information read from the boarding pass is transmitted from the user device 30 to the duty free allowance analysis server 20.

At step 604, the destination look up component 224a of the duty free allowance analysis server 20 looks up the destination of the passenger in the airline passenger database 40 using the information read by the user device 20 from the boarding pass. In step 604, the age of the passenger may also be looked up.

At step 606, the passenger is authenticated. Step 606 may comprise the passenger entering a PIN number or password into the user device 20. The PIN number or password may be a one-time password (OTP) sent to the passenger's mobile telephone. The authentication is required to maintain a customer's session on the server side which allows calculation of the allowance and amount for the passenger.

At step 608, the duty free allowance look up component 224b of the duty free allowance analysis server 20 looks up the duty free allowance for the destination in the duty free allowance database 60.

At step 610 the passenger scans items and adds the items to their basket or trolley. In one embodiment, the items have Radio-frequency identification (RFID) tags attached to them which are read by a RFID reader incorporated in the user device 30 which is mounted on the basket or trolley. In such an embodiment, the items are scanned and identified as the passenger places them into the trolley. In another embodiment, the passenger scans barcodes or QR code with the user device 30 as the items are placed into the basket or trolley. The information read from the barcodes or tags is transmitted from the user device 30 to the duty free allowance analysis server 20.

At step 612, the product look up component 224c of the duty free allowance analysis server 20 looks up product details for the scanned products in the product database 50 using the information such as a product identification number read from the barcode or tag by the user device 30. The product details looked up in the product database 50 are used to determine the content of the product. For example, if the product is a bottle of whiskey, the product details may indicate the amount of whiskey contained in the bottle, for example 1 liter, the alcohol content of the whiskey, for example 40%, and the type and subtype of the product, for example, alcohol and spirit respectively. Depending on the duty free allowance for the destination country, the duty free allowance analysis module 224d extracts content details corresponding to the duty free allowance for the destination country from the product details. For example if the destination country is the USA, the duty free allowance analysis module 224d extracts the type of product, which in this example is alcohol, and the amount, which in this example is 1 liter. However for other destination countries, different information may be extracted, for example if the destination country is Spain, the duty free analysis module extracts the alcohol content and uses this information to determine which subtype of the duty free allowance the bottle of whiskey falls into.

In step 612, the duty free allowance analysis server 20 may also look up price information for each of the items in the basket or shopping trolley. This price information may be stored in the product database 50.

In step 614 the duty free allowance analysis module 224d of the duty free allowance analysis server 20 compares the content of the scanned items with the duty free allowance for the destination country.

As described above in relation to FIG. 5, step 614 may comprise the duty free allowance analysis component 224d determining an amount of each product or product sub-type that is included in the basket and comparing that with the duty free allowance for the destination country. For example, if the destination country is Spain, the duty free allowance analysis component 224d will determine the amount of beer, wine and spirits contained in the basket and compare the amount of each with the duty free allowance specified in the duty free allowance for Spain.

In step 616, the duty free allowance analysis server 20 outputs an indication of whether the basket content is within the duty free allowance. Step 616 may comprise the duty free allowance analysis server 20 sending an indication to the user device 30 which is displayed on the display 340 of the user device.

In step 616, an indication of the total price of the items in the basket or trolley may also be output and displayed to the user on the user device 30.

In step 618, a passenger request to check out is received. This request may be input by the passenger into the user device 30 by selecting an option to check out on the display 340 of the user device 30 using the user interface 320 of the user device 30.

In step 620, processing of a transaction for payment is initiated by the duty free allowance analysis server 20. The transaction may be a payment card based transaction which is processed over the payment network 70. The payment network can be any electronic payment network which connects, directly and/or indirectly payers (consumers and/or their banks or similar financial institutions) with payees (the merchants and/or their banks or similar financial institutions). Non-limiting examples of the payment network are a payment card type of network such as the payment processing network operated by MasterCard, Inc., The various communication may take place via any types of network, for example, virtual private network (VPN), the Internet, a local area and/or wide area network (LAN and/or WAN), and so on. In order to authenticate the transaction, the duty free allowance analysis server 20 may provide authentication information to a payment transaction server as part of a payment authorization request. The payment transaction server compares the authentication information included in the payment authorization request with stored authentication information to determine whether to authorize the payment request.

Whilst the foregoing description has described exemplary embodiments, it will be understood by those skilled in the art that many variations of the embodiment can be made within the scope and spirit of the present invention.

1. A computer implemented method of providing an indication whether a basket content is within a duty free allowance, the method comprising
receiving, in a duty free allowance analysis server, destination indication information for a passenger;
determining, in a destination look up component of the duty free allowance analysis server, a destination of the passenger from the destination indication information;
looking up a duty free allowance for the destination in a duty free allowance database;
receiving, in the duty free allowance analysis server, an indication of a basket content, the basket content comprising at least one product selected by the passenger;
looking up product information for the basket content in a product database;
comparing, in a duty free allowance analysis component of the duty free allowance analysis server, product content information determined from the product information with the duty free allowance for the destination; and
outputting an indication of whether the basket content is within the duty free allowance.

2. A method according to claim 1 wherein the destination indication information for the passenger is an indication of a travel document for the passenger and wherein determining a destination of the passenger from the destination indication information comprises looking up the destination of the passenger in an airline passenger database.

3. A method according to claim 2, further comprising looking up an indication of an age of the passenger in the airline passenger database, and wherein looking up a duty free allowance for the destination further comprises looking up a minimum age associated with a duty free allowance for the destination, the method further comprising comparing the age of the passenger with the minimum age associated with a duty free allowance for the destination.

4. A method according to claim 1, further comprising outputting an indication of a remaining duty free allowance for the passenger.

5. A method according to claim 1 wherein the duty free allowance for the destination specifies the duty free allowance as an indication of at least one product type and an duty free amount of that product type, and wherein the method further comprises determining product content information from the product information, the product content information indicating content amount of the product type contained within the product.

6. A method according to claim 1, further comprising looking up a price for each product in the basket and calculating a total price for the basket.

7. A method according to claim 6 further comprising processing a payment for the products in the basket over a payment network.

8. An apparatus for providing an indication whether a basket content is within a duty free allowance, the apparatus comprising:
a computer processor and a data storage device, the data storage device having a destination look up component, a duty free allowance look up component, a product look up component and a duty free allowance analysis component comprising non-transitory instructions operative by the processor to:
receive destination indication information for a passenger;
determine a destination of the passenger from the destination indication information;
looking up a duty free allowance for the destination in a duty free allowance database;
receive an indication of a basket content, the basket content comprising at least one product selected by the passenger;
looking up product information for the basket content in a product database;
compare product content information determined from the product information with the duty free allowance for the destination; and
output an indication of whether the basket content is within the duty free allowance.

9. An apparatus according to claim 8, wherein the destination indication information for the passenger is an indication of a travel document for the passenger and the destination look up component further comprises non-transitory instructions operative by the processor to look up the destination of the passenger in an airline passenger database.

10. An apparatus according to claim 9, wherein the destination look up component further comprises non-transitory instructions operative by the processor to look up an indication of an age of the passenger in the airline passenger database, and wherein the duty free allowance look up component further comprises non-transitory instructions operative by the processor to look up a minimum age associated with a duty free allowance for the destination, the duty free allowance analysis component further comprising non-transitory instructions operative by the processor to compare the age of the passenger with the minimum age associated with a duty free allowance for the destination.

11. An apparatus according to claim 10, the data storage device further comprising non-transitory instructions operative by the processor to output an indication of a remaining duty free allowance for the passenger.

12. An apparatus according to claim 10, wherein the duty free allowance for the destination specifies the duty free allowance as an indication of at least one product type and an duty free amount of that product type, and wherein the data storage device further comprises non-transitory instructions operative by the processor to determine product content information from the product information, the product content information indicating content amount of the product type contained within the product.

13. An apparatus according to claim 10, wherein the product look up component further comprises non-transitory instructions operative by the processor to look up a price for each product in the basket and the data storage device further comprises non-transitory instructions operative by the processor to calculate a total price for the basket.

14. An apparatus according to claim 13 wherein the data storage device further comprises non-transitory instructions operative by the processor to process a payment for the products in the basket over a payment network.
